(19) United States
(12) Patent Application Publication
(10) Pub. No.: US 2006/0104562 A1
(43) Pub. Date: May 18, 2006

(54) Printed circuit board comprising electrical conductor paths and means for electro-optical and/or opto-electrical conversion

(76) Inventors: Jorg Rosch, Finsing (DE); Frank-Peter Schiefelbein, Potsdam (DE)

Correspondence Address: Siemens Corporation;Intellectual Property Department, 170 Wood Avenue south, Iselin, NJ, 08830, US

(21) Appl. No.: 10/525,631

(22) PCT Filed: Aug. 13, 2003
(86) PCT No.: PCT/DE03/02729

§ 371 Date: Feb. 24, 2005

(30) Foreign Application Priority Data
Sep. 5, 2002 (DE) 102 41 203.0

(51) Int. Cl. G02B 6/12

(52) U.S. Cl. 385/14; 385/24

(57) ABSTRACT

The invention relates to a printed circuit board comprising electrical conductor paths, said printed circuit board also being provided with optical conductor paths. Furthermore, electro-optical or opto-electrical means are provided on or in the printed circuit board.

### CROSS REFERENCE TO RELATED APPLICATION

This application is the US National Stage of International Application No. PCT/DE2003/002729, filed Aug. 13, 2003 and claims the benefit thereof. The International Application claims the benefits of German Patent application No. 10241203.0 DE filed Sep. 5, 2002, both of the applications are incorporated by reference herein in their entirety.

### FIELD OF THE INVENTION

The invention relates to a printed circuit board according to the preamble of the claims.

### BACKGROUND OF THE INVENTION

As a result of the increasing miniaturization of electronics, the performance capability of electronic components, modules and systems is improving. In the area of data processing and data transmission, as well as in telecommunications, this is finding expression in increasing clock rates and data rates. In specialist circles, it is assumed that the clock frequency of processors will rise from about 1 GHz in 1999 to over 10 GHz in 2012/2014.

The performance capability of processors can only be utilized if the external connections enable the transmission and processing as well as the switching, multiplexing and demultiplexing of these high frequencies. Due to crosstalk, reflections and line losses, the demands in terms of electrical construction and connection technology become more and more critical as frequency increases. Due to inadequate connection technology, the potential of processors can often not be utilized.

New electrical solutions and concepts for this problem are associated with high costs.

As an alternative, optical components or devices are increasingly used for transmission. Electrical problems are avoided by means of the optical technology.

Previously, these optical components or devices were mounted on printed circuit boards. In this case, the optical components are connected by means of optical waveguides. The optical waveguides of one or more printed circuit boards are in this case connected to one another by means of splicing or optical connectors. They often lead to other discretely constructed modules. These structures avoid electrical problems, but are relatively time-consuming to construct and are cost-intensive.

### SUMMARY OF THE INVENTION

The object of the present invention is to reveal a simple connection technology for optical components.

This object is achieved in the printed circuit board according to the claims.

Through the integration of electrical and optical connections or conductor paths on a printed circuit board, optical components or devices of electrical circuits can easily be connected to one another. Likewise, optical circuits can be integrated and the power supply to optical components or the control of optical components can be implemented by means of electrical circuits on a printed circuit board.

Advantageous embodiments of the invention are specified in the subclaims.

In one embodiment, the optical conductor paths or connections are fashioned as optical waveguides. This has the advantage of providing particularly low-attenuation and low-distortion connections.

In a further embodiment, the printed circuit board is fashioned as a multilayer printed circuit board, i.e. it consists of a plurality of layers. A layer can in each case contain electrical or optical connections. Mixed forms are also possible. The layers of electrical and optical connections or conductor paths do not have to be alternating. There can also be a plurality of layers of one type which in turn lie above a plurality of layers of the other type.

Here, the inner conductor paths can be reached by accesses at right angles relative to the plane of the conductor paths. The conductor paths can also be fashioned so as to lead through laterally.

The use of a multilayer printed circuit board has the advantage that complex electrical and optical circuits can be integrated on one printed circuit board.

In one embodiment of the invention, the optical components or devices are integrated in the printed circuit board. This has the advantage that integrated optics are possible, i.e. for example, micro-electrical-mechanical systems, MEMS for short, which optionally emit an optical signal at one of two outlets, are integrated. By this means, the advantages of the integrated optics can be combined with the advantages of the electronics on the printed circuit board.

Through doping of the optical conductor paths, linear and non-linear optical effects can be achieved, advantageously integrated on a printed circuit board.

### BRIEF DESCRIPTION OF THE DRAWINGS

Exemplary embodiments of the invention will be explained in detail below and are represented in the drawings, in which

FIG. 1 shows a schematic representation of a printed circuit board with an electrical and an optical plane and an electro-optical device.

FIG. 2 shows an exemplary embodiment with a multilayer printed circuit board.

FIG. 3 shows a further exemplary embodiment with a multilayer printed circuit board which carries optical signals of differing wavelengths.

FIG. 4 shows a section for an embodiment of an optical layer in a cross-sectional representation showing perspective.

FIG. 5 shows a block diagram of an add/drop multiplexer.

FIG. 6 shows an internal structure of the add/drop multiplexer according to FIG. 5.

### DETAILED DESCRIPTION OF THE INVENTION

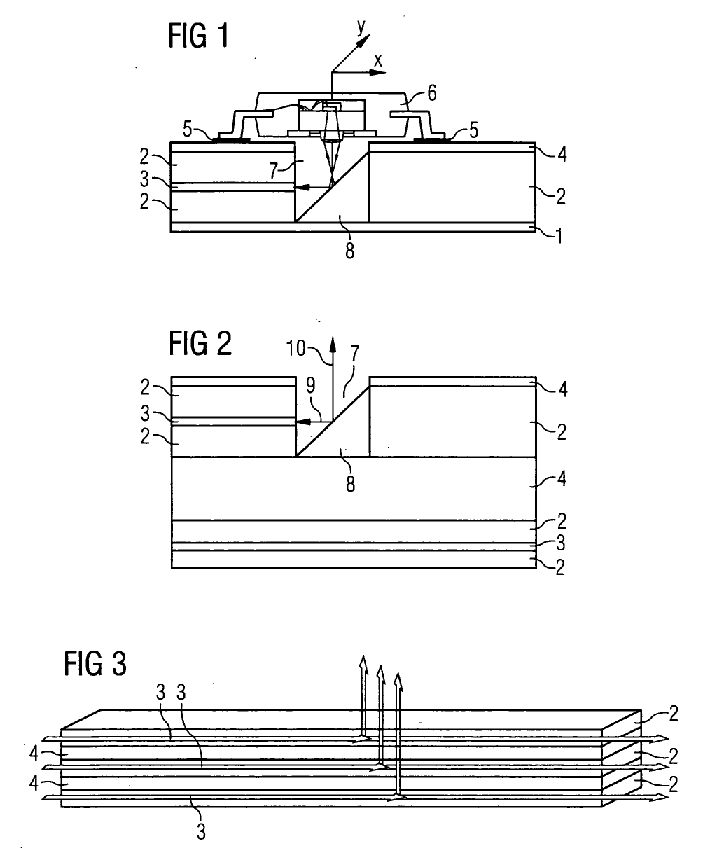

FIG. 1 shows a printed circuit board LP. This consists of a base layer 1, an optical layer 2 which has an optical conductor path 3, for example an optical waveguide, an electrical layer 4 which is electrically insulating and has electrically conductive conductor paths 5. An electro-optical device 6 is connected to the electrical conductor paths, said electro-optical device 6 being arranged on a connecting opening 7 to the optical layer 2. The optical side of the electro-optical device 6 is effectively connected optically by means of an optical coupling element 8, for example a mirror or micro-electrical-mechanical system, called MEMS for short, to the optical conductor path 3.

FIG. 2 shows an representation analogous to FIG. 1 with the difference that further layers are shown. FIG. 2 shows two optical layers 2 and two electrical layers or planes 4 with conductor paths not shown, a connecting opening 7 and an optical coupling element 8. The arrow 9, which leads from the optical conductor path 3 to the optical coupling element 8, and the arrow 10, which leads outward from the optical coupling element 8, show schematically the path of a coupled or decoupled optical signal.

By analogy with FIG. 2, FIG. 3 shows schematically a printed circuit board with a plurality of layers, for example a multilayer board or multilayer printed circuit board. Here, various optical signals, for example of differing wavelength, are transmitted in the optical layers.

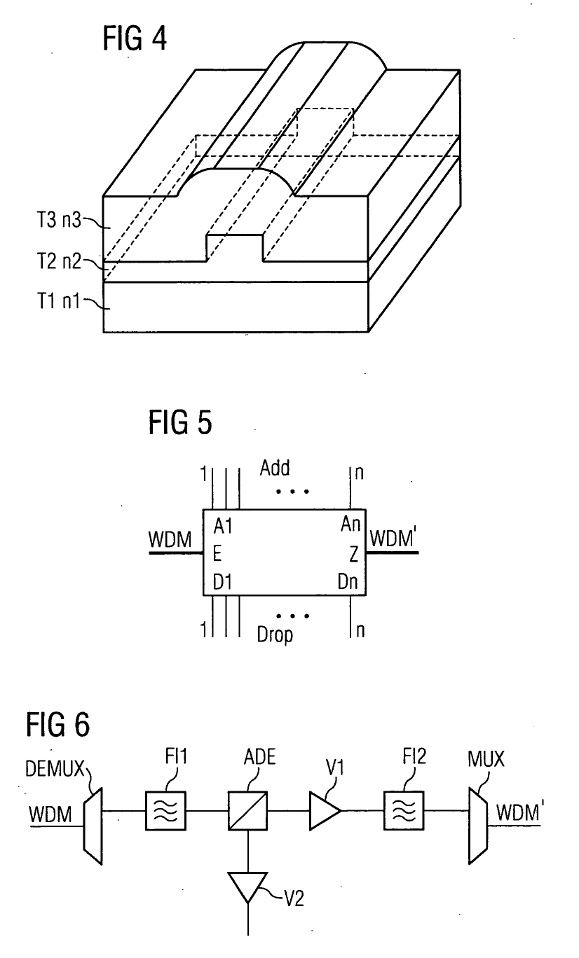

FIG. 4 shows a section of an embodiment of the optical layer 2. Here, this layer consists of a first sublayer T1 with a first refractive index n1. Arranged above this is a second sublayer T2 with a second refractive index n2. This second sublayer has a light-conducting or light-wave-guiding cross-sectional profile, and in the example this is a raised rectangular channel. Arranged on the sublayer 2 is a further sublayer 3 with a third refractive index n3. In general, the refractive index of the central sublayer T2 has to be greater than that of the lower or upper sublayer T1 or T3, i.e. the condition n2>n1 and n2>n3 must be fulfilled. However, refractive-index ratios deviating from this are also conceivable.

In the example, the rectangular-shaped channel of the sublayer 2 functions as an optical conductor.

FIG. 5 shows a block diagram of an add/drop multiplexer. Here, a wavelength division multiplex signal WDM is fed to the input E. This signal consists of a plurality of independent optical signals which are transported on differing wavelengths.

In the add/drop multiplexer, the signal of one wavelength can, depending on the switching status, be conducted outwardly—to the so-called drop side—and removed from the respective output D1 . . . Dn. In parallel with this, a signal of an unused or outwardly conducted channel of the wavelength division multiplex signal can be added. This occurs on the add side at the respective input A1 . . . An.

After a channel has been dropped or added, a correspondingly changed wavelength division multiplex signal WDM is emitted at output Z.

FIG. 6 shows the basic internal structure of such an add-drop multiplexer according to FIG. 5.

The wavelength division multiplex signal WDM is firstly fed to a demultiplexer DEMUX. This divides the fed signal in accordance with the number of channels into a plurality of subsignals. One channel is shown in the representation. This subsignal is fed to a first optical filter FI1 which forwards a filtered signal to an add/drop device ADE. This device can be fashioned for example as a micro-electrical-mechanical system, MEMS for short. The decoupled or coupled signal can optionally be amplified by means of the amplifiers V1 and V2 and is fed via a second filter FI2 to the multiplexer MUX which combines it with the other channels, not shown, to form a new multiplex signal WDM.

This arrangement is usually constructed discretely. It can advantageously be integrated by using the printed circuit board according to the invention. Here, the demultiplexers, filters, micro-electrical-mechanical systems, amplifiers and multiplexers can be integrated on a printed circuit board together with the control electronics or further-processing electronics.

The need for time-consuming splicings, etc. is avoided in this way and the overall arrangement is more compact and more cost-effective.

As electro-optical, opto-electrical or optical means covering passive and active functions and constructed on organic and/or inorganic materials, micro-electrical-mechanical systems, MEMS for short, can comprise optical filters such as gain flatness filters and tilt filters, optical switches, optical amplifiers such as fiber amplifiers or semiconductor laser amplifiers doped with erbium or other rare earths, laser diodes, photodiodes, arrayed waveguide gratings (AWGs for short), branches or taps, optical modulators such as Mach-Zehnder modulators or electro-absorption modulators, and other means of this kind.

By integrating electro-optical means such as for example laser diodes, refractive-index-changing components, optical amplifiers, optical switches and opto-electrical means such as for example photodiodes into the printed circuit board, i.e. passive, such as switching and attenuating, and active, such as amplifying, non-linear effects and functions, a compact and cost-effective structure is attained. Here, inorganic and organic materials can advantageously be combined in order to obtain desired optical or electrical properties.

For example, polymer can be used in place of glass, silicon oxide or silicon dioxide for the optical conductor paths.

Optical amplifiers such as for example erbium-doped fiber amplifiers, EDFA for short, erbium-doped waveguide amplifiers, EDWA for short, semiconductor laser amplifiers or semiconductor optical amplifiers, SOA for short, consist of a plurality of components such as monitor photodiodes, pump lasers, filters and fiber splices. Optical amplifiers can advantageously be integrated by using the printed circuit board according to the invention.

The multilayer printed circuit board is manufactured with optical and electrical layers. Optical waveguides and suitable optical switches, such as MEMS, which enable a coupling and decoupling of the optical signal are incorporated in the optical layers which consist of thin glass or polymers and where applicable are doped, for example with erbium. Input and output optical signals can be fed to a fiber connector or connector strip which is arranged in, on or near the printed circuit board. The electrical and optical contacts or connecting elements of the printed circuit board can be combined or fashioned individually.

Three-dimensional optical structures can also be integrated into the printed circuit board.

With the printed circuit board, the optical signal can be forwarded from one layer to another layer and supply various means, devices or components.

Various optical signals can be bundled or separated in integrated multiplexers, demultiplexers, splitters and tap-couplers. In the optical layer, optical amplifiers which balance losses and effect an adjustment of the light signal can be achieved through doping.

In addition to the previous functions the electrical layers take over the power supply and the monitoring and control of the electrical, electronic, electro-optical, opto-electrical and optical devices.

The hybrid construction of circuits, flipchip assembly or other connection technologies are possible in order to integrate devices.

The printed circuit boards according to the invention can be used not only in data communications and telecommunications engineering but also for example in automotive engineering, medical technology, power-station engineering, etc.

The advantages mentioned and the advantages resulting from optical integration include, beside the reduction of overall dimensions and the improved repetition accuracies in production, the following.

An integrated solution in the circuit holder or the printed circuit board is possible in the place of individual components. An integrated arrangement generally needs smaller electrical field dimensions, therefore less energy, which in turn means fewer disruptions such as through electromagnetic incompatibility, EMI for short.

The major outlay in terms of working time required for the precise positioning of fiberoptic modules and the associated costs are minimized by the integration according to the invention, as fiber splices are no longer necessary.

A printed circuit board can contain a complete optical add/drop multiplexer.

A facility has been created for cost-effective production, control and integration of optical switches.

1-8. (canceled)

9. An electrically controlled optical add-drop multiplexer, comprising:
a multiplexer;
a demultiplexer;
an optical filter;
a micro-electrical-mechanical system; and
an optical amplifier,
wherein the multiplexer, the demultiplexer the optical filter, the micro-electrical-mechanical system and the optical amplifier are arranged on a multilayer printed circuit board comprising at least one electrically insulating layer, at least one electrically conductive conductor path on an upper surface of the at least one electrically insulating layer to which the optical add-drop multiplexer is electrically connected, at least one optical layer beneath the at least one electrically insulating layer, a connecting opening formed within the at least one optical layer, an optical coupling element within the connecting opening whereby the optical add-drop multiplexer is oriented above the optical coupling element so that an optical signal exiting the optical add-drop multiplexer is redirected by the optical coupling element to an optical waveguide formed within the at least one optical layer.

10. The add-drop multiplexer according to claim 9, wherein a layer of the multilayer printed circuit board has both optical and electrical conductor paths.

11. The add-drop multiplexer according to claim 9, wherein the multilayer printed circuit board has organic and inorganic materials.

12. The add-drop multiplexer according to claim 9, wherein the multilayer printed circuit board has organic or inorganic materials.

13. The add-drop multiplexer according to claim 9, the optical conductor paths are made of glass and polymers.

14. The add-drop multiplexer according to claim 9, the optical conductor paths are made of glass or polymers.

15. The add-drop multiplexer according to claim 9, wherein the optical conductor paths are fashioned from an element from the group consisting of: glass, silicon oxide, silicon dioxide, and polymer.

16. The add-drop multiplexer according to claim 9, wherein the optical conductor paths have three-dimensional optical structures such that two optical conductor paths arranged in different layers of the multilayer printed circuit board are connected to one another.

17. The add-drop multiplexer according to claim 9, the optical conductor paths contain a doping.

18. The add-drop multiplexer according to claim 9, wherein the add-drop multiplexer further comprises; an electro-optical device, an opto-electrical device, and an optical device.

19. An electrically controlled electro-optical device comprising:
an optical side connected optically to an optical coupling element positioned within a connecting opening formed within an optical layer of a multi-layer printed circuit board, the electro-optical device being electrically connected with at least one electrically conductive path formed on an electrically insulting layer of the multi-layer printed circuit board positioned above the optical layer whereby an optical signal exiting the electro-optical device is redirected substantially orthogonally by the optical coupling element to an optical waveguide formed within the optical layer of the multi-layer printed circuit board.
